(19) United States
(12) Patent Application Publication
(10) Pub. No.: US 2007/0116243 A1
(43) Pub. Date: May 24, 2007

(54) Method of dualizing access terminal information of an ohm in an evdo system

(75) Inventor: Hyung Nam Ahn, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom Kor

(21) Appl. No.: 10/557,116

(22) PCT Filed: May 28, 2004
(86) PCT No.: PCT/KR04/01270

§ 371 Date: Nov. 28, 2006

(30) Foreign Application Priority Data
May 30, 2003 (KR) 10-2003-0034804

(51) Int. Cl. H04M 3/00; H04M 5/00

(52) U.S. Cl. 379/310

(57) ABSTRACT

The present invention relates to a method of dual Acess Terminal (AT) information of an Overhead Manager (OHM) in an Evolution Data Only (EVDO) control system. The method of the present invention allows both an active OHM and a standby OHM to manage OHM Mobile Terminal (OHMMT) information, such as Radio Link Protocol (RLP) and Signaling Manager (RSM) resource information allocated for each call requested by a terminal, Random Access Terminal ID (RATI) information, Unicast Access Terminal ID (UATI) information allowed when the terminal requests a call, and object addresses connected to a Selector Function (SF) allocated to the terminal that requests a call. Under dualization, terminal call information between the active OHM and the standby OHM coincide and terminal call information is sent from the active OHM to the standby OHM when the standby OHM restarts. By doing so, when the active OHM has trouble, the standby OHM can provide EVDO service without a break, thereby guaranteeing continuity of service even though system touble occurs.

### TECHNICAL FIELD

The present invention relates to a method of dual Access Terminal (AT) information of an Overhead Manager (OHM) in an Evolution Data Only (EVDO) control system. The method of the present invention allows both an active OHM and a standby OHM to manage OHM Mobile Terminal (OHMMT) information, such as Radio Link Protocol (RLP) and Signaling Manager (RSM) resource information allocated for each call requested by a terminal, Random Access Terminal ID (RATI) information, Unicast Access Terminal ID (UATI) information allowed when the terminal requests a call, and object addresses connected to a Selector Function (SF) allocated to the terminal that requests the call. Under dualization, terminal call information between the active OHM and the standby OHM coincide and terminal call information is sent from the active OHM to the standby OHM when the standby OHM restarts. By doing so, when the active OHM has trouble, the standby OHM can provide EVDO service without a break, thereby guaranteeing continuity of service even though system trouble occurs.

### BACKGROUND ART

Conventionally, an OHM software block having an IP based signal processing structure does not consider the scheme of dualization, and thus cannot ensure the stability or reliability of the mobile service.

Reference materials include TIA/IS-856 and TIA/IS-878A relating to a CDMA 2000 1x EVDO system.

The present invention intends to solve this problem by dualizing session information of an AT.

### DISCLOSURE OF THE INVENTION

The object of the present invention is to provide a method of dual AT information of an OHM in an EVDO control system, wherein when the active OHM has trouble, the standby OHM can provide EVDO service without a break, thereby guaranteeing the continuity of service even though system trouble occurs.

To accomplish the object, the method of the present invention allows both an active OHM and a standby OHM to manage OHM Mobile Terminal (OHMMT) information, such as Radio Link Protocol (RLP) and Signaling Manager (RSM) resource information allocated for each call requested by a terminal, Random Access Terminal ID (RATI) information, Unicast Access Terminal ID (UATI) information allowed when the terminal requests a call, and object addresses connected to a Selector Function (SF) allocated to the terminal that requests a call. Under dualization, terminal call information between the active. OHM and the standby OHM coincide and terminal call information is sent from the active OHM to the standby OHM when the standby OHM restarts.

To accomplish the object, a procedure for allocating a UATI comprises the step of:

allocating the UATI after receiving a UATI request message (UATIRequest) (including RATI) from an Access Terminal (AT) in an active OHM;

selecting a Selector Function (SF) block resource that will process wireless protocol and route packets;

sending a Radio Link Protocol (RLP) and Signaling Manager (RSM) allocation request message (AllocateRSMRsp) to the selected SF block;

sending the UATIRequest received from the AT together with the allocated UATI information to the SF block;

sending the UATI allocation message (UATIAssignment) to the AT in the SF block that received said message; and

sending a UATI completion message (UATIComplete) indicating the completion of the UATI allocation to the OHM.

Also, to accomplish the object of the present invention, a procedure for reallocating a UATI comprises the step of:

allocating a new UATI if an active OHM receives a UATI Read Request message (GetUATIReq) from an SF block;

sending to the SF block a UATI Read Response message (GetUATIRsp) that comprises the allocated new UATI information;

delivering the new UATI information from the SF block to the AT using a UATIAssignment; and

receiving a UATI completion message (UATIComplete) from the AT.

Further, to accomplish the object of the present invention, if a standby OHM restarts, a procedure for updating OHMMT information and processing in the standby OHM comprises the step of:

sending a_sby_restart_ind message to an active OHM;

delivering to the standby OEM OHMMT information presently managed by the active OHM that received the message;

examining the received present UATI at the standby OHM that received the information, and determining whether the same information exists in the present standby OHM;

if the same information does not exist, generating an OHMMT information object of a new AT; and

setting the OHMMT information object with new information received from the active OHM.

According to the present invention, the method of the present invention allows both an active OHM and a standby OHM to manage OHM Mobile Terminal (OHMMT) information, such as Radio Link Protocol (RLP) and Signaling Manager (RSM) resource information allocated for each call requested by a terminal, Random Access Terminal ID (RATI) information, Unicast Access Terminal ID (UATI) information allowed when the terminal requests a call, and object addresses connected to a Selector Function (SF) allocated to the terminal that requests a call. Under dualization, terminal call information between the active OHM and the standby OHM coincide and terminal call information is sent from the active OHM to the standby OHM when the standby OHM restarts. By doing so, when the active OHM has trouble, the standby OHM can provide EVDO service without a break, thereby guaranteeing continuity of service even though system trouble occurs.

### BRIEF DESCRIPTION OF DRAWINGS

FIG. 1 shows a system configuration for dual AT information of OHM in an EVDO control station according to the present invention.

FIG. 2 shows a procedure for allocating a UATI of OHMMT information according to the present invention.

FIG. 3 shows a procedure for reallocating a UATI according to the present invention.

FIG. 4 shows a procedure for updating OHMMT information when a standby OHM restarts according to the present invention.

### BEST MODE FOR CARRYING OUT THE INVENTION

The preferred embodiment of the present invention according to the above-mentioned technical features of the present invention is described below, together with drawings.

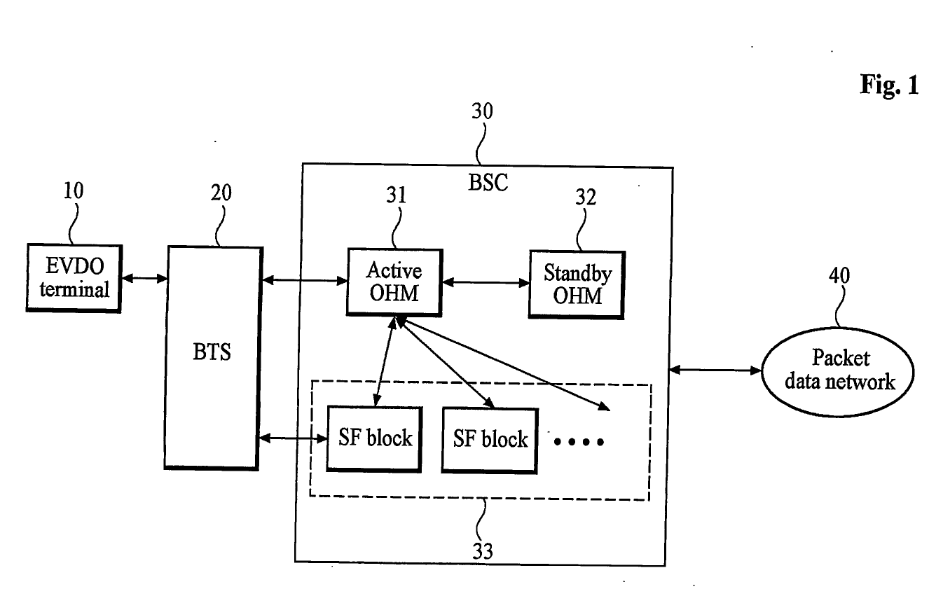

FIG. 1 shows a system configuration for dual AT information of an OHM in an EVDO control station according to the present invention.

As shown in FIG. 1, the system for providing EVDO service according to the present invention comprises EVDO terminal (AT) 10, Base Station Transceiver

Subsystem (BTS) 20, Base Station Controller (BSC) 30, which includes active OHM 31, standby OHM 32 and SF blocks 33, and a packet data network.

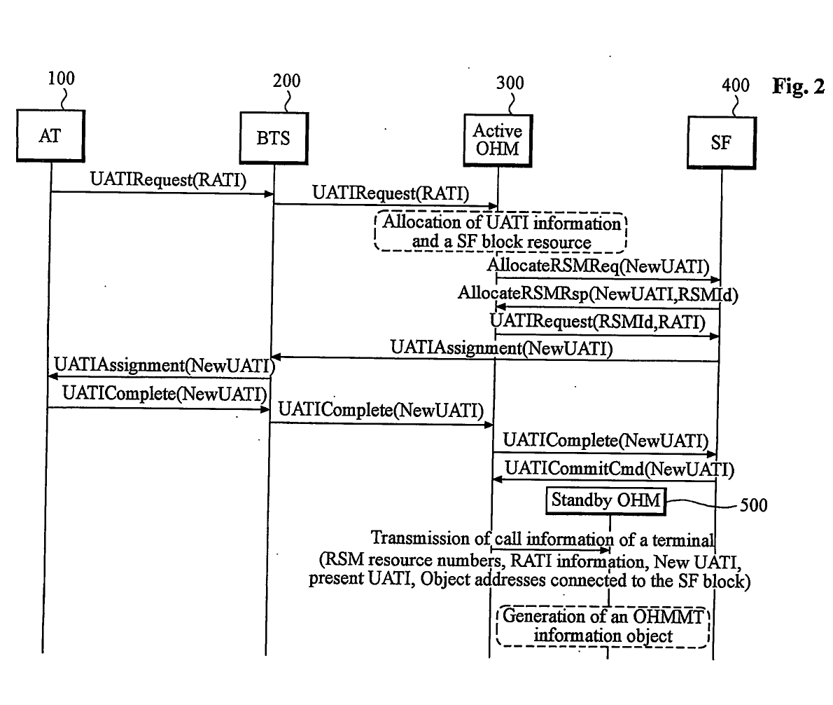

The system performs the allocation of a UATI for an AT, allocation of resources for processing wireless protocol and delivering packets, and processing of signal messages as shown in FIG. 2.

FIG. 2 shows a procedure for allocating a UATI of OHMMT information according to the present invention.

As shown in FIG. 2, a procedure for allocating a UATI comprises the step of allocating the UATI after receiving a UATI request message (UATIRequest) (including RATI) from an AT in an active OHM, selecting an SF block resource that will process wireless protocol and route packets, sending an RSM allocation request message (AllocateRSMRsp) to the selected SF block, sending the UATIRequest received from the AT together with the allocated UATI information to the SF block, sending the UATI allocation message (UATIAssignment) to the AT in the SF block that received the message, and sending an UATI completion message (UATIComplete) indicating the completion of the UATI allocation to the OHM.

The procedure further comprises the step of sending OHMMT information from the active OHM to a standby OHM to make call information of the AT coincident.

Detailed descriptions of the allocation of a UATI according to the present invention are as follow:

First, in active OHM 300, after a UATI request message (UATIRequest), which includes RATI information from AT 100, has been received, the UATI is allocated and SF block 400 resource, which will process a wireless protocol and route packets, is selected.

Then, an RSM allocation request message (AllocateRSMRsp) is sent to selected SF block 400. If AllocateRSMRsp, which is a response message for the RSM allocation request, is received from SF block 400, the UATIRequest received from AT 100 is sent to SF block 400, together with the allocated UATI information.

The UATI allocation message (UATIAssignment) is sent to AT 100 in SF block 400, and an UATI completion message (UATIComplete) indicating the completion of the UATI allocation is sent to the OHM in AT 100.

If the procedure for allocating a UATI is performed successfully, OHMMT information (RSM resource numbers of the SF block, RATI information, UATI information, and object addresses connected to the SF block) is sent from active OHM 300 to standby OHM 500 to make call information of the AT coincident.

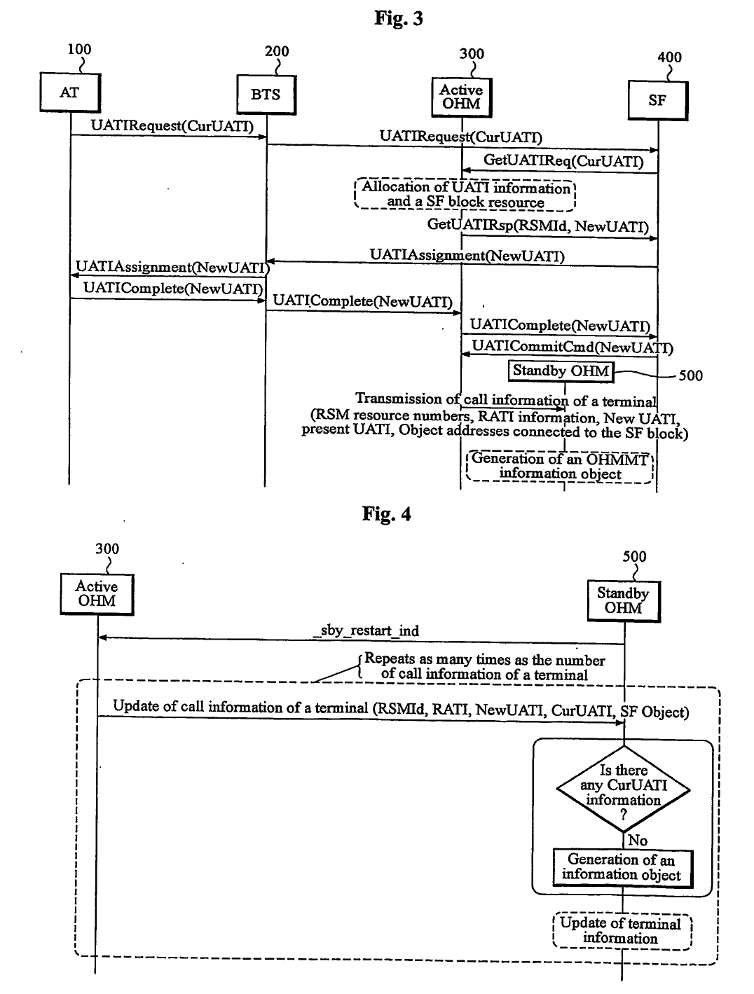

FIG. 3 shows a procedure for reallocating a UATI according to the present invention.

As shown in FIG. 3, a procedure for reallocating a UATI comprises the step of allocating a new UATI if an active OHM receives a UATI Read Request message (GetUATIReq) from a SF block, sending to the SF block a UATI Read Response message (GetUATIRsp) that comprises the allocated new UATI information, delivering the new UATI information from the SF block to the AT using UATIAssignment, and receiving a UATIComplete from the AT.

The procedure further comprises the step of sending OHMMT information from the active OHM to a standby OHM to make call information of the AT coincident.

Detailed descriptions of the reallocation of a UATI according to the present invention are as follow:

First, if active OHM 300 receives a UATI Read Request message (GetUATIReq) from SF block 400, then a new UATI is allocated.

Then, the new UATI information is delivered to AT 100, and UATIComplete is received from AT 100.

If the procedure for reallocating a UATI is performed successfully, OHMMT information (RSM resource numbers of the SF block, RATI information, UATI information, and object addresses connected to the SF block) is sent from active OHM 300 to standby OHM 500 to make call information of the AT coincident.

The procedures for matching call information of the AT in FIGS. 2 and 3 will be described in detailed below.

FIG. 4 shows a procedure for updating OHMMT information when a standby OHM restarts according to the present invention.

As shown in FIG. 4, when a standby OHM restarts, OHMMT information is updated and processed in the standby OHM.

The procedure comprises the steps of sending a_sby_restart_ind message to an active OHM, delivering to the standby OHM OHMMT information presently managed by the active OHM that received the message, examining the received present UATI at the standby OHM that received the information and determining whether the same information exists in the present standby OHM, generating an OHMMT information object of a new AT if the same information does not exist, and setting the OHMMT information object with new information received from the active OHM.

In other words, as described above, to update OHMMT information in a standby OHM according to the present invention, after standby OHM 500 restarts, a_sby_restart_ind message is sent to active OHM 300, and OHMMT information presently managed by active OHM 300 is sent to standby OHM 500.

Also, in standby OHM 500, which received the OHMMT information, a present UATI received from active OHM 300 is examined, and whether the same information exists in present standby OHM 500 is determined.

If the same information does not exist, an OHMMT information object of new AT 100 is generated.

The OHMMT information object is set with new information received from active OHM 300. Thus, the OHMMT information is updated when a standby OHM restarts and call information of the AT is matched.

Although the present invention was described with respect to a particular embodiment of the method, it will be apparent to those skilled in the art that many changes and modifications may be made without departing from the scope of the invention as defined in the appended claims and those equivalent thereto.

1. A method of dual Access Terminal (AT) information of an Overhead Manager (OHM) in an Evolution Data Only (EVDO) control system, comprising the steps of:
allocating the UATI after receiving a UATI request message (UATIRequest) (including RATI) from an Access Terminal (AT) in an active OHM;
selecting a Selector Function (SF) block resource that will process wireless protocol and route packets;
sending a Radio Link Protocol (RLP) and Signaling Manager (RSM) allocation request message (AllocateRSMRsp) to the selected SF block;
sending the UATIRequest received from the AT, together with the allocated UATI information to the SF block;
sending the UATI allocation message (UATIAssignment) to the AT in the SF block that received the message; and
sending an UATI completion message (UATIComplete) indicating the completion of the UATI allocation to the OHM.

2. A method of dual AT information of an OHM in an EVDO control system, comprising the steps of:
allocating a new UATI if an active OHM receives a UATI Read Request message (GetUATIReq) from an SF block;
sending to the SF block a UATI Read Response message (GetUATIRsp) that comprises the allocated new UATI information;
delivering the new UATI information from the SF block to the AT using an UATI allocation message (UATIAssignment); and
receiving a UATI completion message (UATIComplete) from the AT.

3. The method of claim 1 or 2, further comprising the step of sending OMH Mobile Terminal (OHMMT) information (RSM resource numbers of the SF block, RATI information, UATI information, and object addresses connected to the SF block) from the active OHM to a standby OHM to make call information of the AT coincident.

4. A method of dual AT information of an OHM in an EVDO control system, wherein when a standby OHM restarts, further comprises the steps of:
sending a_sby_restart_ind message to an active OHM;
delivering to the standby OHM OHMMT information presently managed by the active OHM that received the message;
examining the received present UATI at the standby OHM that received the information, and determining whether the same information exists in the present standby OHM;
if the same information does not exist, generating an OHMMT information object of a new AT; and
setting the OHMMT information object with new information received from the active OHM.
